(19) United States
(12) Patent Application Publication
(10) Pub. No.: US 2014/0278800 A1
(43) Pub. Date: Sep. 18, 2014

(54) SYSTEMS, DEVICES, AND METHODS FOR GENERATING LOCATION ESTABLISHMENT SEVERITY IDENTIFICATION

(71) Applicant: TACO BELL, CORP., Irvine, CA (US)

(72) Inventors: Mark Nguyen, Newport Beach, CA (US); Lynn Hemans, Costa Mesa, CA (US)

(73) Assignee: Taco Bell, Corp., Irvine, CA (US)

(21) Appl. No.: 13/840,324

(22) Filed: Mar. 15, 2013

(51) Int. Cl. G06Q 30/02

(52) U.S. Cl. CPC G06Q 30/0205
USPC 705/7.34

(57) ABSTRACT

A computer system for real-time generation of location establishment severity profile alert based on aggregated quality-data corresponding to a plurality of location establishments is provided herein. A computer system provides for the electronic intake, and aggregate analysis of quality-data for establishment locations. Quality-data is accessed from one or more sources, and corresponds to multiple establishment locations. The system stores quality-data events identifying received quality-data, with a stored representation of a quality-data event's severity level. The system aggregates the stored quality-data events for example by calculating aggregate severity values associated with groups of establishment locations. In some embodiments, quality-data and/or aggregate severity values are normalized according to one or more factors, such as historic geographic data. Resulting aggregate data is then provided, such as through a graphical user interface that graphically codes regions according to their aggregate severity values.

### BACKGROUND

1. Field of the Disclosure

This disclosure relates generally to the field of data analysis, and more particularly to a computer system that provides for the intake and aggregate analysis of quality-data for retail stores and other location establishments.

2. Description of Related Art

Tracking, monitoring, and analyzing electronic data relating to customer service and/or customer experience and/or complaints is generally vital to the management of many businesses. The owners and/or operators of retail stores other location establishments continually seek to improve the quality of the retail experiences that they offer their customers. For example, some stores provide customer feedback call centers which permit customers to make telephone calls in order to provide feedback regarding both positive and negative experiences. Alternative or additionally, a store may provide a website with a customer feedback web form permitting customers to provide feedback regarding such experiences.

Some people and organizations manage large numbers of retail stores. Such stores may be distributed across wide geographic areas, such as a nationwide food chain that may have stores in many different states. Store owners and operators seek to monitor, maintain, and improve the quality of their customers' experiences across these distributed locations. Owners and operators of distributed retail stores would benefit from a system that takes in data representative of quality measures at the stores, from one or more sources, and aggregates that data according to categories for improved analysis.

### SUMMARY

In an embodiment, a computer system for real-time generation of location establishment severity profile alert based on aggregated quality-data corresponding to a plurality of location establishments, the computer system comprises a quality-data intake interface configured to receive by the computer system over a computer network quality-data from a plurality of quality-data sources, said quality-data representative of measures of quality at said location establishments, wherein measures of quality include measures of one or more of service quality, product quality, facility quality, safety quality, customer satisfaction, and employee satisfaction. The system can comprise a quality data store configured to electronically store the quality-data as quality-data events, wherein a quality-data event is associated with a severity value and one or more of the location establishments. In an embodiment, the system can comprise a quality-data aggregation controller configured to (1) calculate, by the computer system, a first aggregate severity value for a first aggregation unit, wherein the first aggregation unit is associated with a first plurality of quality-data events, at least in part based on the severity values of at least one of the first plurality of quality-data events; and (2) calculate, by the computer system, a second aggregate severity value for a second aggregation unit, wherein the second aggregation unit is associated with a second plurality of quality-data events, at least in part based on the severity values of at least one of the second plurality of quality-data events. The system can comprise a quality-data transmission interface configured to transmit the first aggregate severity value and the second aggregate severity value.

In an embodiment, a computer-implemented method for providing information regarding aggregated quality-data corresponding to a plurality of location establishments, the method comprises receiving by a computer system through a computer network quality-data from a plurality of quality-data sources, said quality-data representative of one or more of service quality, product quality, facility quality, safety quality, customer satisfaction, and employee satisfaction at the location establishments. The computer-implemented method can comprise storing in an electronic data storage the quality-data as quality-data events, wherein a quality-data event is associated with a severity value and one or more of the location establishments. In an embodiment, the computer-implemented method comprises calculating by the computer system a first aggregate severity value for a first aggregation unit, wherein the first aggregation unit is associated with a first plurality of quality-data events, at least in part based on the severity values of at least one of the first plurality of quality-data events. The computer-implemented method can comprise calculating by the computer system a second aggregate severity value for a second aggregation unit, wherein the second aggregation unit is associated with a second plurality of quality-data events, at least in part based on the severity values of at least one of the second plurality of quality-data events. In an embodiment, the computer-implemented method comprises transmitting by the computer system the first aggregate severity value and the second aggregate severity value, wherein said computer system comprises a computer processor and an electronic memory.

In an embodiment, a computer-readable, non-transitory storage medium having a computer program stored thereon for causing a suitably programmed computer system to process by one or more computer processors computer-program code for performing at least accessing by a computer system through a computer network quality-data from a plurality of quality-data sources, said quality-data representative of one or more of service quality, product quality, facility quality, safety quality, customer satisfaction, and employee satisfaction at the location establishments; storing in an electronic data storage the quality-data as quality-data events, wherein a quality-data event is associated with a severity value and one or more of the location establishments; calculating by the computer system a first aggregate severity value for a first aggregation unit, wherein the first aggregation unit is associated with a first plurality of quality-data events, at least in part based on the severity values of at least one of the first plurality of quality-data events; calculating by the computer system a second aggregate severity value for a second aggregation unit, wherein the second aggregation unit is associated with a second plurality of quality-data events, at least in part based on the severity values of at least one of the second plurality of quality-data events; and transmitting by the computer system the first aggregate severity value and the second aggregate severity value. In an embodiment, the accessing is by querying a database of transaction data for at least 1000 transactions.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF DRAWINGS

The accompanying drawings, which are incorporated in and form a part of this specification, illustrate example embodiments of the inventive subject matter, and in no way limit the scope of protection. The accompanying drawings include examples of possible graphical user interfaces for use with the disclosed system and methods. Other embodiments are contemplated using alternate hardware and/or software platforms, and using significantly different interfaces. The accompanying drawings illustrate embodiments wherein:

FIG. 1 depicts one embodiment of a system for retail store quality-data aggregation and analysis, including an intake service that receives quality-data from a plurality of sources.

FIG. 2 illustrates one example of a graphical representation of aggregated quality-data for a set of distributed retail stores, including a detailed pop-up menu with quality-data for a selected store.

FIG. 3 illustrates another example of a graphical representation of aggregated quality-data for a set of distributed retail stores. There is shown graphical controls for filtering, normalizing, and otherwise altering the displayed quality-data.

FIG. 4 illustrates another example of a graphical representation of aggregated quality-data for a set of distributed retail stores. The quality-data is provided based on aggregation by geographic region.

FIG. 5 depicts another embodiment of a system for retail store quality-data aggregation and analysis. The depicted embodiment includes a plurality of intake services, each receiving quality-data from a different source.

FIG. 6 illustrates a method for performing quality-data event aggregation for a plurality of quality-data events, according to identified store, severity, and region attributes.

FIG. 7 illustrates a method for calculating a state's aggregate severity score.

FIGS. 8a and 8b illustrate another method for calculating a state's aggregate severity score.

### DETAILED DESCRIPTION

With reference to FIG. 1, a computing architecture diagram is shown for one embodiment of a system for providing aggregate information regarding quality metrics at retail stores or other establishment locations. The system may be used, for example, by an owner, manager, auditor, or other person or entity in order to effectively monitor the quality at a large number retail store locations and according to a variety of data sources. In the illustrated embodiment, the system provides information allowing a fast food chain to identify regions where its stores are providing slower service than what the chain's service standards call for. In another example, the food chain may use the system in order to identify a group of stores categorized by franchisee, rather than by region, in order to identify whether the professionalism of service by employees of a particular franchisee is falling short of the chain's service standards. Such aggregation may be useful as a potential indicator that a franchisee is failing to provide sufficient training to employees. Through obtaining quality-data from multiple sources, the system provides robust, prompt information regarding quality. The information depicts quality-data that can be analyzed according to a variety of techniques, and visualized through a graphical user interface, such as the one shown in FIG. 2.

With reference to FIG. 2, an example user interface of one embodiment is shown, where quality-data is shown aggregated according to individual states in the contiguous United States. More darkly shaded states have higher aggregate severity values compared to more lightly shaded states. The system depicts as non-shaded those states with no aggregate severity value, either because they have no monitored retail stores, or they have stores but the system has not received quality-data identifying any severity events at the stores. The system provides user-selectable depictions of individual stores, and provides more detailed information to the user in response to the user's selection of a store.

### Quality-Data and Sources

In one embodiment, quality-data describes one or more measures of quality at a retail store or retail stores. Examples of retail stores include (1) food service retail stores, including fast food restaurants, casual dining restaurants, and formal dining restaurants; (2) retail product stores, including grocery stores, home goods stores, consumer goods stores, electronics stores, car dealerships; (3) rental stores, including car rental locations; and (4) retail service stores, such as cellular network stores, barber's shops, salons, and pet grooming stores. For convenience, embodiments will typically be described herein as relating to quality-data for retail stores. It will be understood by one of ordinary skill in the art that quality-data may alternatively describe other entities capable of being monitored, besides retail stores. For example, in other embodiments, quality-data describes a business office, a medical care facility, or movie theater.

Quality-data may describe one or more different types of measurable quality. For example, quality-data may describe service quality, product quality, facility quality, safety quality, customer satisfaction, and/or employee satisfaction at a store. Quality data may describe particular incidents relevant to measures of quality, or may more generally describe a quality level at a particular store or stores. With reference to FIG. 1, an embodiment of a system for performing aggregation and analysis of quality-data is shown. In this embodiment, the system receives quality-data from a plurality of quality-data sources, 101-105, including a Customer Feedback Call Center Quality-Data Source 101, a Customer Feedback Web Form Quality-Data Source 102, an Employee Report Quality-Data Source 103, a Social Media Quality-Data Source 104, and an Automated Service Monitoring Quality-Data Source 105. In the illustrated service, a quality-data source is a service that transmits quality-data to a quality-data intake service of the illustrated system. A quality-data source may transmit the quality-data in response to a request for quality-data, or may initiate the transmission on its own, for example on a recurring basis. A quality-data source may be distinct from the system itself, and may communicate with the system, for example through a network such as the Internet. In other embodiments, some or all of the quality-data sources form a part of the system, for example by running on one of the computer servers that hosts other services comprising the system, or by running on the same local intranet as such servers.

In the present embodiment, the Customer Feedback Call Center Quality-Data Source provides quality-data generated from a telephone call center that receives customer feedback telephone calls. For example, a store customer may call the call center and inform a customer service representative of the customer's experience at the store. The customer service representative may enter information into a computer system based on the customer's statements, for example by identifying the store that the customer is discussing, the date and time of the incident, whether it was a positive experience or a negative experience, the severity of the experience, a category describing the type of experience, a descriptive statement regarding the experience, a particular retail product relevant to the experience, and/or other relevant information. In another embodiment, a customer feedback call center obtains all or some of the information from the user programmatically, such as through asking the user to enter in numeric values in response to questions about the customer's experience. In yet another embodiment, a customer feedback call center uses speech recognition in order to identify relevant information that the customer describes regarding the experience.

One use-case example for the illustrated embodiment occurs when a customer has a particularly positive experience at a retail food store, based on an employee there being especially helpful and the customer enjoying the food at the retail food store. The customer may notice on his receipt that the store is part of a chain which provides a feedback telephone number for customers. The customer in this example calls the phone number and informs a customer service representative of the positive aspects of the experience, including the food items ordered, the name of the helpful employee, the date and time of the event, and a rating of overall satisfaction using a 1-to-10 scale. The customer service representative enters relevant information into a graphical user interface for a customer feedback entry service running on a computer. For example, this and other computer-based services may operate in one or more programming languages, such as Java, J2EE, C#, C++, Python, Visual Basic, a NET framework language, etc. Alternatively or additionally, the service may comprise a data entry frontend and a database backend, such as using one or more of Microsoft Access, SQL, or Oracle.

The customer feedback data may be stored in a format unique to the customer feedback call center, or may use a format shared by other quality-data sources. A Customer Feedback Call Center Quality-Data Service 101 provides at least some of the quality-data generated during the customer's telephone call to a Quality-Data Intake Service 110. In certain embodiments, the Customer Feedback Call Center Quality-Data Service 101 may transmit quality-data using one or more electronic formats such as Simple Object Access Protocol (SOAP), Rich Site Summary (RSS), HyperText Markup Language (HTML), and flat files. The quality-data source may transmit the files in response to a request, such as by providing a SOAP interface, or other application programming interface (API) available to receive requests for quality-data and respond with such data. Alternatively or additionally, a quality-data source may transmit quality-data to one or more predetermined recipient services or devices without being queried by those services or devices. For example, a quality-data service may be configured to transmit, every evening, all quality-data that it has gathered since its previous successful transmission.

The illustrated embodiment also communicates with a Customer Feedback Web Form Quality-Data Source 102. For example, a retail store corporation may provide a website that includes a web form for customers to provide feedback regarding their experiences at the corporation's stores. In one example, a customer is provided with a receipt that includes a unique identifier code and the uniform resource locator (URL) for the customer feedback website. The customer feedback web form system receives a customer feedback web form submitted by the customer, including the unique identifier code, and uses that code in order to identify various attributes of the customer's experience, including store number, date, time, items ordered, the identity of the employee who took the order from the customer, and the identity of other employees responsible for the order, such as the cooks on duty at the time. In another embodiment, a web form requests some of this information from the user.

As an example use case, a customer orders food from a restaurant and feels that the food would benefit from being more seasoned with salt and pepper. The customer's receipt includes a unique order identification code, and a message informing the customer that she can leave feedback at the restaurant's website. The customer visits the website, is presented with a feedback web form, and enters the unique order identification code into the web form. The customer also leaves a short description stating that she prefers her food to have more salt and pepper seasoning. A service queries a database of customer orders using the unique order identification code and associates the customer's seasoning suggestion with the particular food items that formed the customer's order.

In the illustrated embodiment, the Customer Feedback Web Form Quality-Data Source 102 provides quality-data to the Quality-Data Intake Service 110, such as through one or more of the manners previously described in the context of the Customer Feedback Call Center Quality-Data Source 101.

The illustrated embodiment also receives quality-data from an Employee Report Quality-Data Source 103, which may provide quality-data based on feedback from employees. This may be gathered using a web-form, a call center, an internal network tool, or through some other technique.

The illustrated embodiment also receives quality-data from a Social Media Quality-Data Source 104. This service provides quality-data that is gathered from one or more social media networks, such as Facebook, Twitter, Google+, LinkedIn, and Myspace. The Social Media Quality-Data Source 104 may provide quality-data that is gathered by querying a social network for key words, such as the name of the retail store or the name of its products. Social media quality-data may also be gathered by monitoring hashtag activity, or by gathering data based on the sources for hyperlink references. For example, in one embodiment, a social media quality-data gathering service queries a social network for all references to a particular retail store within the past week. The service then analyzes the social media messages that refer to the retail store by name and look for the presence of other terms that indicate like or dislike (e.g., “delicious,” “great,” “disappointing,” etc.) In another embodiment, the service gathers data based on social media electronic preferences indications, such as Facebook “likes” and Google+“+1's.” In yet another embodiment, the service gathers relevant social media messages and a person reviews the messages and categorizes them according to positive/negative, severity, category, and description.

In another embodiment, the Social Media Quality-Data Source 104 also provides quality-data that is gathered from one or more blog networks, such as Blogger and WordPress. In yet another embodiment, the Social Media Quality-Data Source 104 gathers data from Youtube comments, for example through analyzing the comments that users have left for a commercial video advertising one of the store's new products.

The illustrated embodiment also receives quality-data from an Automated Service Monitoring Quality-Data Source 105. In one example, an order timer installed at a fast-food drive-through generates quality-data based upon the amount of time that is spent fulfilling orders. A timer begins when a new vehicle is detected in front of a food pick-up window. The timer counts the amount of time spent until the order is completed, which may be detected based upon detecting that the car has departed from the pick-up window, or based on action by an employee.

Various embodiments may obtain quality-data from one or more other sources than those shown in FIG. 1. For example, other sources may provide quality-data based on information obtained from a supplier, an inspection agency, or government agency.

### Quality-Data Events

The illustrated embodiment includes a Quality-Data Intake Service 110 in communication with a plurality of quality-data sources 101-105. The Quality-Data Intake Service 110 receives quality-data from the sources and may format or otherwise process the quality-data, for example into a quality-data event format. For example, two different quality-data sources may provide quality-data in different formats and the Quality-Data Intake Service 110 may standardize the format of the quality-data received from the different quality-data sources.

In the illustrated embodiment, the Quality-Data Intake Service 110 is in communication with a Quality-Data Intake Parameter Database 111, that it uses in interpreting the parameter formatting of quality-data that it receives from quality-data sources. In one example, one quality-data source may include a parameter labeled “category” which includes a short descriptor of one particular customer encounter. A different quality-data source may encode the same type of information using a parameter labeled “type.” The Quality-Data Intake Parameter Database stores data identifying that, when processing data from the first quality-data source in order to generate a quality-data event data object, the “Event Type” field for the quality-data event data object should be populated by the value of the “category” parameter; the Quality-Data Intake Parameter Database similarly stores data identifying that, when processing data from the second quality-data source in order to generate a quality-data event data object, the “Event Type” field for the quality-data event data object should be populated by the value of the “type” parameter.

In another example, a first quality-data source may provide severity data formatted into using a scale of 1 through 10, with 1 indicating a very non-severe event, and 10 indicating a very severe event. A second quality-data source may provide severity data formatted using the descriptors “High,” “Medium,” and “Low.” The system in this example may store quality-data as quality-data events in a Quality Database 120. A quality-data event in the illustrated embodiment includes an “Event Severity” field, which includes a numeric value between 1 and 5, with 1 indicating a very non-severe event, and 5 indicating a very severe event. The Quality-Data Intake Parameter Database 111 stores data defining the mapping of severity levels from the formats provided by various quality-data sources, into the format used in the Quality Database 120. For example, the Quality-Data Intake Parameter Database 111 may store data indicating that, for the first quality-data source, the provided severity value should be divided in two and then rounded down to the nearest integer. The Quality-Data Intake Parameter Database 111 may also store data indicating that, for the second quality-data source, a “High” severity will be represented as a 5 integer value in the Quality Database 120, a “Medium” severity will be represented as a 3 integer value in the Quality Database 120, and a “Low” severity will be represented as a 1 integer value in the Quality Database 120.

In another example, the Quality-Data Intake Parameter Database 111 may store data indicating that a first quality-data source provides date data formatted in “yyyy-mm-dd” format, and that a second quality-data source provides date data formatted in “mmddyyyy” format. The Quality-Data Intake Service 110 accesses the Quality-Data Intake Parameter Database 111 and uses the format data in order to interpret the quality-data that it receives from the quality-data sources 101-105. In another embodiment, some or all quality-data sources provided quality-data to a Quality-Data Intake Service in a standard format and the Quality-Data Intake Service does not rely upon a Quality-Data Intake Parameter Database.

In the present embodiment, the Quality-Data Intake Service 110 causes quality-data to be stored in a Quality Database 120 as quality-data events. A Quality Database 120 stores quality-data events. The Quality Database may be comprised of one or more information storage structures, including a SQL database, an Oracle database, an Access database, a flat file, and/or a file directory structure. The Quality Database 120 may be a distributed storage system, such as a cloud-based storage system.

A quality-data event may store various data fields describing a particular event, such as customer's experience at a retail store, an employee's report of a safety issue, or an automated service monitoring event showing slower than desired order fulfillment at a particular store. The quality-data event fields of the present embodiment include a quality-data event identifier, store identifier, employee identifier, event type, event description, event severity, event date, event time, and food ordered, 120. In one embodiment, different quality-data events stored in a quality database 120 may contain different fields than those of the illustrated embodiment in FIG. 1.

In the illustrated embodiment, the Quality-Data Intake Service 110 receives quality-data from a quality-data source, such as the Social Media Quality-Data Source 104, and causes the Quality Database 120 to store a new quality-data event representative of that received quality-data. The Quality-Data Intake Service parses a relevant social media message in order to identify the location of the retail store that it addresses. If the social media message (e.g., tweet, blog post, Facebook comment) does not identify a particular retail store, the system may treat the message as generally concerning those retail stores in the area of the message author. For example, the system may query the social media network in order to determine the city in which the author lives, if such information is publicly available in the author's profile. The system may then associate the customer's message with stores in the customer's city, even if a particular store has not been identified. The Quality-Data Intake Service 110 posts the data to the Quality Database 120 as a new entry, uniquely identifiable by a quality-data event identifier. The Quality-Data Intake Service 110 may, over time, cause large quantities of quality-data events to be stored in the Quality Database 120. In another embodiment, a plurality of quality-data intake services cause quality-data events to be stored in one or more quality databases.

The Quality Database 120 shown in FIG. 1 stores data for a plurality of quality-data events. One such quality-data event is identified with the identifier number 898172. The Quality-Database 120 stores information indicating that quality-data event number 898172 corresponds to a store identified as number 53, and employee number 413. The database 120 data includes an Event Type field that indicates that the event relates to an incident of slow service at the retail store. The description explains that the event represents a customer experience in which a drive-thru order took 8 minutes to complete. The event is coded with a severity level of 2. The event data indicates that the event took place on Jul. 13, 2012 at 6:45 p.m., and that the retail food order was for a crunchy taco.

In one embodiment, the Quality-Data Intake Service 110 determines a severity score for a quality-data event based at least in part on the corresponding quality-data provided by a quality-data source. For example, the Quality-Data Intake Service 110 may be configured to assign any “slow service” type event to a severity level of 2. Alternatively, the Quality-Data Intake Service 110 may analyze the received quality-data to determine the extent of the slowness, assigning a severity level of 2 to a delay of less than 10 minutes, and a severity level of 3 otherwise. In another example, a user interface requests that the customer providing feedback rate their level of happiness or unhappiness, and a severity score is determined based at least in part on that information.

### Aggregation

The illustrated embodiment of FIG. 1 includes a Quality-Data Aggregation Service 121 that receives quality-data event information from the Quality Database 120 and aggregates the quality-data events in order to generate aggregate data. The Quality-Data Aggregation Service 121 may perform a number of different aggregations, each using one or more aggregation factors. In the illustrated embodiment, the Quality-Data Aggregation Service 121 generates aggregate data that is stored in a Quality Aggregate Database 130. The Quality-Data Aggregation Service 121 calculates an annual aggregate severity score for each store that has one or more quality-data events stored in the Quality Database 120. For example, the Quality-Data Aggregation Service 121 calculates that store number 53 had a year 2012 aggregate severity score of 3, and a year 2011 aggregate severity score of 2. As will be described herein in greater detail, the Quality-Data Aggregation Service 121 may use one or more algorithms, charts, or other solutions in order to generate an aggregate severity score for a given set of quality-data events. The illustrated embodiment also demonstrates that the Quality-data Aggregation Service 121 may perform multiple aggregations, using a variety of different aggregation parameters. For example, the Quality-Data Aggregation Service 121 calculates that all stores in California have an aggregate severity level of 1 for the year 2012.

In one example, the Quality-Data Aggregation Service 121 iterates through all quality-data event entries in the Quality Database 120 and evaluates each entry against a series of aggregation rules. Each aggregation rule includes a Boolean condition, and if the Boolean condition is satisfied for a quality-data event, that quality-data event is used in calculating an aggregate severity for that aggregation rule. For example, in the Quality Aggregate Database 130 of the illustrated embodiment, there is a depiction of a 2012 Aggregate Severity score of 3. The Quality-Data Aggregation Service 121 uses the Boolean rule: ((YEAR=2012) AND (STORE=#53)) in calculating that aggregate severity score.

The Quality-data Aggregation Service 121 may access an Asset Information Database 122 in performing aggregation. For example, the Asset Information Database 122 may provide information for various assets, such as stores, and the Quality-Data Aggregation Service 121 may use that information during aggregation. In one embodiment, the Asset Information Database 122 stores address information for stores. A store's nation, state, and geographic region can be determined based on the store's unique identifier, using the Asset Information Database 122. The Asset Information Database may include database entries keyed using a store's unique identifier, for example. In the illustrated embodiment, because individual quality-data events do not list a store's address, the Quality-Data Aggregation Service uses the Asset Information Database 122 to translate the store identifier within a quality-data event into a state, in order to calculate state aggregate severity levels.

For example, the Quality-Data Aggregation Service 121 may aggregate all quality-data events for stores in Florida during the year 2012. As another example, the Quality-Data Aggregation Service 121 may aggregate all quality-data events corresponding to insufficient parking spaces reported between 11 a.m. and 2 p.m., as aggregated by geographic region (e.g., Northeast U.S., Southern U.S., Midwest U.S., Southwest U.S., and Western U.S.), broken out annually. In another example, the Quality Database 120 stores quality-data events corresponding to events in a variety of different countries, and the Quality-Data Aggregation Service 121 aggregates events according to country.

In one embodiment, the Quality-Data Aggregation Service 121 runs at scheduled times in order to update the Quality Aggregate Database 130. In another embodiment, the Quality-Data Aggregation Service 121 runs in response a triggers, such as newly received quality-data events in the Quality Database 120, a user request, a programmatic initialization, or some other event. The Quality-Data Aggregation Service 121 may repeatedly update the aggregate data in the Quality Aggregate Database 130.

### Normalization

The present embodiment includes a Quality-Data Normalization Service 140 in communication with the Quality Aggregate Database 130. The Quality-Data Normalization Service 140 normalizes aggregate data according to one or more normalization factors.

The Quality-Data Normalization Service 140 may receive data from the Quality-Aggregate Database 130 regarding aggregate severity values, normalize those values, and then cause the Quality Aggregate Database 130 with normalized, aggregate severity values. For example, customers in one geographic region may accept a slower pace of service as compared to customers in another region. The Quality-Data Normalization Service 140 includes functionality to normalize severity values based on geographic region. A user may benefit from viewing normalized aggregate severity values, as compared to non-normalized aggregate severity values, because normalized severity values draw greater attention to abnormalities and other situations requiring a higher degree of attention. The Quality-Data Normalization Service 140 may access a Normalization Parameter Database 141 and use data stored therein during normalization. For example, the Normalization Parameter Database may provide data indicating historic trends for severity levels according to one or more parameters.

### Reporting and Searching

The embodiment of FIG. 1 also includes a Quality-Data Search Service 150 that provides search functionality for quality-data events and/or aggregate severity values. For example, the system may provide a user interface that permits a user to enter search criteria. The system may receive a user search request for all quality-data events and aggregate severity values corresponding to store number 53. The Quality-Data Search Service 150, in response, causes a search in both the Quality Database 120 and the Quality Aggregate Database 130 for data entries corresponding to store number 53. In another example, a search may include as parameters a timeframe, an employee number, an event type, an event severity level, and/or a product item. The system may provide the user with the results of the search in a graphical user interface.

The present embodiment also includes a Quality-Data Report Service 152. This service may provide recurring or on-demand report generation based on quality-data events and/or aggregate data. For example, the Quality-Data Report Service 152 may be configured to automatically email a user with a monthly report providing: (1) the year-to-date aggregate severity level for each regions that the user manages, (2) summary descriptions of all quality-data events with a severity value of 5 that have occurred in the most recent month, and (3) the name and identification number for the employee, in the region that the user manages, who has the most positive customer feedback reports during the most recent month. In another example, the Quality-Data Report Service 152 generates a report based upon a user's request through a graphical user interface, or in response to a programmatic request.

### Visualization

The illustrated system includes a Quality-Data Visualization Service 151 that provides graphical user interface to a user of a computer 160. With reference to FIG. 2, one example of such a graphical user interface is shown. The system provides a graphical depiction of aggregate severity data, aggregated by the contiguous United States. More darkly shaded states have higher aggregate severity scores, while more lightly shaded states have lower aggregate severity scores. For example, California is shown with a very light shading, indicating an aggregate severity score of 1. Oregon is shown with a moderate shading, indicating an aggregate severity score of 3. Utah is shown with a dark shading, indicating an aggregate severity score of 5. In other embodiments, color, texture, or other visual effects may be used to indicate severity scores. In the illustrated embodiment, unshaded states, such as Montana, have no aggregate severity score, for example because there is no monitored store in that state, or because none of the monitored stores have a reported quality-data event during the relevant timeframe.

The graphical representation also includes icons depicting individual stores. The system may receive a user input indicating a user selection of one of the individual store icons, for example in response to a user selecting the icon with a mouse-click. The system in the illustrated embodiment provides a detailed context menu 220 in response to receiving the user input. The context menu 220 provides details regarding the selected store, organized according to quality-data event. In this example, the graphical user interface allows the user to choose between having individual quality-data events visually expanded or unexpanded. Quality-data event numbers 898172 (221) and 899763 (222) are shown expanded, while two other events are shown unexpanded (223). In one embodiment, elements of the context menu can be selected, and the system responds by providing further information. For example, in response to receiving a user input corresponding to a mouse-click on the “Slow Service” text, the system may perform a query for all quality-data events of that type and provide the results to the user.

With reference to FIG. 3, another example is shown of a graphical representation of aggregated quality-data. FIG. 3 includes a map showing aggregated severity values for individual states 301, and includes controls for altering the information displayed. The interface provides an event type filtering control 330 which permits the user to select or deselect certain types of events from being included in the severity aggregation values. For example, if the quality-data events reveal that the vast majority of complaints from Oregon stores relate to slow service, and the user deselects the slow service event type from the control option 330, the system will modify the displayed, aggregated severity value 301 and lighten the shading for Oregon to reflect an aggregated severity value that excludes slow service events in its calculation. In one embodiment, the system stores aggregated severity values for multiple permutations of event types being selected or deselected, so that such information is available without further aggregation calculations being performed in response to a selection change. In another event, the system performs aggregation in response to a selection change.

The illustrated embodiment also includes a normalization control 340. The normalization control allows the user to select various attributes to normalize the displayed severity values according to. For example, the system may store or otherwise have access to data indicating seasonal trends in certain types of quality-data events. In response to receiving a user input selecting seasonal normalization, the system normalizes the severity data based on that historic, seasonal data. As a result, the displayed, aggregated severity values 301 are based on the extent of deviation from the baseline severity values of the historic data.

As another example, historic data may indicate that there are a larger number of insufficient parking events reported during lunch hours, between 11:30 a.m. and 1:00 p.m. If the “time of day” normalization control is unchecked, the system displays aggregated severity values which are determined in part based on such insufficient parking events. This may make it more difficult for a user to recognize stores, states, or regions where there is a particularly abnormal parking problem. In response to receiving a user selection for normalization by time of day, the system may filter out the baseline events that historic data shows to regularly fluctuate with time of day.

As another example, newer stores may experience some learning curve in a variety of areas, including bringing their service speed and professionalism up to the standards of older stores. A manager may wish to view aggregation data that takes this fact into account, and may select the “age of store” normalization control. In response, the system's aggregated severity values will reduce the weight given to certain quality-data events at stores that have recently opened. For example, a store's severity events may carry less weight if the store has been open for less than 3 months.

The illustrated embodiment also includes a historic data visualization control 360. The historic data visualization control 360 includes a timeline 361 for the timespan for which historic aggregation data is available. A selection arrow 362 indicates the point in time for which the graphical representation 301 corresponds to. In response to a user input moving the selection arrow 362 to a different point on the timeline 361, the system alters the graphical display 301 to correspond to the data available at that point in time. In one embodiment, the system updates the graphical display 301 as the user drags the selection arrow 362 along the timeline 361, resulting in a visual animation of change over time in the graphical display 301. In another embodiment, the historic data visualization control 360 includes a starting selection arrow and an ending selection arrow, allowing a user to specify a time range for data aggregation. The system may then calculate aggregation severity values in the selected timespan and modify the graphical display 301 to represent those severity values.

With reference to FIG. 4, the another graphical display of aggregate severity information is shown 401. Based upon a user-input to an aggregation control 350, the monitored stores are aggregated according to geographic region, with individual regions 402-405 shaded according to their aggregate severity scores. In this embodiment, the icons for individual stores graphically reflect the store's aggregate severity score. For example, one store 410 in the western region 402 is shaded dark, representing a higher severity score. Another store 411 in the upper Midwest region 403 is unshaded, representing a severity score of 0. Yet another store 412 in that region is moderately shaded, representing a moderate severity score.

### Real-Time Analysis

With reference to FIG. 5, an alternative embodiment for providing quality-data aggregation is shown. A plurality of quality-data sources 101-104 provide quality-data to a plurality of quality-data intake services 511-514. The quality-data intake services 511-514 cause quality-data events to be stored in a Quality Database 520. A Quality-Data Real-Time Analysis Service 530 is in communication with the Quality Database 520 and performs on-demand aggregation of the quality-data events. For example, if a user changes an aggregation parameter using a graphical user interface, the Quality-Data Visualization Service 151 receives that user input and transmits an aggregation request to the Quality-Data Real-Time Analysis Service 530. The Quality-Data Real-Time Analysis Service 530 performs the requested aggregation and provides the resulting data, such as aggregate severity values, back to the Quality-Data Visualization Service 151, which then modifies a graphical representation based thereon. Similarly, the Quality-Data Report Service 152 communicates requests for real-time aggregation to the Quality-Data Real-Time Analysis Service 530.

In another embodiment, a combination of stored aggregation data and on-demand aggregation analysis is used. For example, a system may include a cache database that stores the results of on-demand aggregations. When a new aggregation request is received, the system first checks the cache to determine whether the same request has been recently satisfied, in which case the cached result may be used without rerunning an aggregation analysis. If no sufficiently up-to-date cached copy exists, a Quality-Data Real-Time Analysis Service 530 performs an aggregation analysis.

### Aggregation and Analysis Methods

Various embodiments of the system may use one or more methods for performing aggregation, including the calculation of an aggregate severity score. With reference to FIG. 6, one method of aggregating quality-data events is shown. The system iterates through the quality-data events in a quality database. For each quality-data event, the value corresponding to the “Store” field and the value corresponding to the “Severity” fields are retrieved. The system maintains counters for each Store-Severity combination, so that if five severity scores are used, for example, then Store #1 has a counter for each severity score. The system checks the Severity value and increments the current Store's severity counter corresponding to that Severity value. The system then calculates the Store's aggregate severity score. In another embodiment, aggregate severity calculations are not necessarily performed during quality-data event iteration, and may instead be performed afterwards. In the illustrated embodiment, once the aggregate severity score has been calculated, there is a determination made as to whether the aggregate severity score for the store exceeds a monitoring threshold. For example, a report rule may be in place that will result in the rapid production and publication of a report corresponding to a store with an aggregate severity score of 5. Alternatively or additionally, an alert may be displayed in a graphical user interface of the present system.

The system continues performing the illustrated method by determining whether the Store is associated with any larger Region. If the Store is associated with a larger Region, the appropriate severity event count for that region is incremented, based on the severity level of the currently iterated quality-data event. In another embodiment, a Store may be associated with a plurality of regions, such as a geographic region and an individual state, in which case multiple severity event counters are incremented. In the illustrated embodiment, the system calculates the Region's aggregate severity score and takes appropriate alert and/or reporting steps if the aggregate severity score exceeds a monitoring threshold. Once the system completes performing these steps for one quality-data event, it iterates to the next quality-data event and performs the steps for that quality-data event. In one embodiment, this loops perpetually, or unless interrupted by a user input or programmatic interrupt command. In another embodiment, once all quality-data events have been iterated through, the process stops until it is started again.

With reference to FIG. 7, there is depicted one example of a method for calculating an aggregate severity score. The illustrated example uses a weighted-sum technique in which quality-data events with a severity score of 5 are given a weight of 5, quality-data events with a severity score of 4 are given a weight of 4, quality-data events with a severity score of 3 are given a weight of 3, quality-data events with a severity score of 2 are given a weight of 2, and quality-data events with a severity score of 1 are given a weight of 1. In other embodiments, other weights may be used. In the present embodiment, if a particular state has 20 stores within it and the state is associated with 23 quality-data events, and one event has a severity score of 5, two events have a severity score of 4, four events have a severity score of 3, six events have a severity score of 2, and ten events have a severity score of 1, then the “weightedSum” variable is calculated as: 1*5+2*4+4*3+6*2+10, which equals 47. The value “weightedAvg” is calculated as weightedSum/n, where n equals 20. weightedAvg is calculated as 47/20, which equals 2.35. The state's aggregate severity score is set to 2, based on a rounded calculation from 2.35. In another embodiment, a severity score may be rounded differently, or may be presented as a non-integer number, such as 2.35.

With reference to FIG. 8, another example is shown for calculating an aggregate severity score. In this example, a weighted sum value is calculated as variable wSum, with severity 5 events having a weight of 20, severity 4 items having a weight of 10, severity 3 items having a weight of 6, severity 2 items having a weight of 2, and severity 1 items having a weight of 1. The algorithm then proceeds through a series of Boolean checks and assigns an aggregate severity score based on the result of those checks. For example, if there are any severity level 5 events associated with a state, the state's severity score is set to 5. This may ensure that high-severity events are given sufficient attention and will not evade detection by being potentially diluted with a large number of less-severe events. The algorithm also assigns a severity score of 5 if there have been a sufficiently high number of severity 4 events such that the ratio “s4/n” exceeds 1/10. The third check which can result in an aggregate severity score of 5 evaluates the weighted sum, and determines whether the weighted sum as a ratio of the total number of stores exceeds a 3/10 threshold. If none of these three Boolean checks succeed, then similar checks are run to determine whether the state will be assigned an aggregate severity score of 4. If none of the aggregate severity score 4 checks are met, then a similar process occurs for an aggregate severity score of 3, and if none of those checks are met, a similar process occurs for an aggregate severity score of 2. In the present embodiment, if a state does not meet any of the checks for an aggregate severity score of 5, 4, 3, or 2, then it is assigned an aggregate severity score of 1. In another embodiment, some such states may be assigned an aggregate severity score of 1 while others are assigned an aggregate severity score of 0, and the determination may be based on one or more variable such as wSum, n, and s1. In other embodiments, entirely different aggregation severity algorithms are used. For example, a particular embodiment may use one aggregation severity algorithm for calculating a store's aggregate severity value, and may use a different aggregation severity algorithm for calculating a state's aggregate severity value.

### CONCLUSION

The system may be implemented as computing system that is programmed or configured to perform the various functions described herein. The computing system may include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computing system includes multiple computing devices, these devices may, but need not, be co-located. The results of the disclosed methods and tasks may be persistently stored by transforming physical storage devices, such as solid state memory chips and/or magnetic disks, into a different state.

Each of the services 101, 102, 103, 104, 105, 110, 121, 140, 150, 151, and 152 shown in FIG. 1 may be implemented in an appropriate combination of computer hardware and software, or in application-specific circuitry. For example, each such service may be implemented in service code executed by one or more physical servers or other computing devices. The service code may be stored on non-transitory computer storage devices or media. The various data repositories 111, 120, 122, 130, and 141 may include persistent data storage devices (hard drives, solid state memory, etc.) that store the disclosed data, and may include associated code for managing such data.

Although the inventions have been described in terms of certain preferred embodiments, other embodiments will be apparent to those of ordinary skilled in the art, including embodiments that do not include all of the features and benefits set forth herein. Accordingly, the invention is defined only by the appended claims. Any manner of software designs, architectures or programming languages can be used in order to implement embodiments of the invention. Components of the invention may be implemented in distributed, cloud-based, and/or web-based manners.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

What is claimed is:

1. A computer system for real-time generation of location establishment severity profile alert based on aggregated quality-data corresponding to a plurality of location establishments, the computer system comprising:
a quality-data intake interface configured to receive by the computer system over a computer network quality-data from a plurality of quality-data sources, said quality-data representative of measures of quality at said location establishments, wherein measures of quality include measures of one or more of service quality, product quality, facility quality, safety quality, customer satisfaction, and employee satisfaction;
a quality data store configured to electronically store the quality-data as quality-data events, wherein a quality-data event is associated with a severity value and one or more of the location establishments;
a quality-data aggregation controller configured to (1) calculate, by the computer system, a first aggregate severity value for a first aggregation unit, wherein the first aggregation unit is associated with a first plurality of quality-data events, at least in part based on the severity values of at least two of the first plurality of quality-data events; and (2) calculate, by the computer system, a second aggregate severity value for a second aggregation unit, wherein the second aggregation unit is associated with a second plurality of quality-data events, at least in part based on the severity values of at least two of the second plurality of quality-data events; and
a quality-data transmission interface configured to transmit the first aggregate severity value and the second aggregate severity value.

2. The computer system of claim 1, wherein the quality-data intake interface is further configured to assess a social media network and identify customer-generated quality data within the social media network.

3. The computer system of claim 1, wherein the quality-data intake interface is further configured to capturing automated service monitoring quality-data by determining the amount of time spent fulfilling an order.

4. The computer system of claim 1, wherein said quality-data event is further associated with one or more of: (1) an employee identification, (2) an event type, (3) an event description, (4) a date, (5) a time, and (6) a retail product.

5. The computer system of claim 1, further comprising a quality-data normalization filter configured to normalize the aggregate severity value for the first aggregation unit.

6. The computer system of claim 5, wherein the quality-data normalization filter is further configured to normalize based on stored, seasonal quality-data, wherein seasonal quality-data is associated with a measure of quality at one or more location establishments for a season.

7. The computer system of claim 5, wherein the quality-data normalization filter is further configured to normalize based on stored, regional quality-data, wherein regional quality-data is associated with a measure of quality at one or more location establishments in a region.

8. The computer system of claim 1, wherein the first aggregation unit is a geographic region.

9. The computer system of claim 1, further comprising a quality-data visualization interface configured to provide a graphical display of the aggregate severity value.

10. The computer system of claim 9, wherein the quality-data visualization interface is further configured to provide a graphical representation of a large geographic area, wherein the large geographic area comprises a plurality of geographic regions, at least one of which is graphically depicted with its aggregate severity value.

11. The computer system of claim 1, further comprising a quality-data report generator configured to generate an aggregate severity report comprising the aggregate severity value, an identification of a timeframe corresponding to the aggregate severity value, and an identifier associated with the plurality of location establishments that the aggregate severity value corresponds to.

12. The computer system of claim 1, wherein the quality-data aggregation controller is further configured to calculate the first aggregate severity value for the first aggregation unit by calculating a weighted average where a higher severity value is given more weight than a lower severity value.

13. A computer-implemented method for providing information regarding aggregated quality-data corresponding to a plurality of location establishments, the method comprising:
receiving by a computer system through a computer network quality-data from a plurality of quality-data sources, said quality-data representative of one or more of service quality, product quality, facility quality, safety quality, customer satisfaction, and employee satisfaction at the location establishments;
storing in an electronic data storage the quality-data as quality-data events, wherein a quality-data event is associated with a severity value and one or more of the location establishments;
calculating by the computer system a first aggregate severity value for a first aggregation unit, wherein the first aggregation unit is associated with a first plurality of quality-data events, at least in part based on the severity values of at least two of the first plurality of quality-data events;
calculating by the computer system a second aggregate severity value for a second aggregation unit, wherein the second aggregation unit is associated with a second plurality of quality-data events, at least in part based on the severity values of at least two of the second plurality of quality-data events; and
transmitting by the computer system the first aggregate severity value and the second aggregate severity value;
wherein said computer system comprises a computer processor and an electronic memory.

14. The computer-implement method of claim 13, wherein the calculating the first and second aggregate severity values is performed in real-time.

15. The computer-implemented method of claim 13, wherein receiving quality-data from a plurality of quality-data sources comprises accessing a social media network, and identifying customer-generated quality data within the social media network.

16. The computer-implemented method of claim 13, wherein receiving quality-data from a plurality of quality-data sources comprises capturing automated service monitoring quality-data by determining the amount of time spent fulfilling an order.

17. The computer-implemented method of claim 13, wherein said quality-data event is further associated with one or more of: (1) an employee identification, (2) an event type, (3) an event description, (4) a date, (5) a time, and (6) a retail product.

18. The computer-implemented method of claim 13, further comprising normalizing the aggregate severity value for the first aggregation unit.

19. The computer-implemented method of claim 18, wherein normalizing the aggregate severity value comprises normalizing based on stored, seasonal quality-data, wherein seasonal quality-data is associated with a measure of quality at one or more location establishments for a season.

20. The computer-implemented method of claim 18, wherein normalizing the aggregate severity value comprises normalizing based on stored, regional quality-data, wherein regional quality-data is associated with a measure of quality at one or more location establishments in a region.

21. The computer-implemented method of claim 13, wherein the first aggregation unit is a geographic region.

22. The computer-implemented method of claim 13, further comprising providing a graphical display of the aggregate severity value.

23. The computer-implemented method of claim 22, wherein providing a graphical display of the aggregate severity value comprises providing a graphical representation of a large geographic area, wherein the large geographic area comprises a plurality of geographic regions, at least one of which is graphically depicted with its aggregate severity value.

24. The computer-implemented method of claim 13, further comprising generating an aggregate severity report comprising the aggregate severity value, an identification of a timeframe corresponding to the aggregate severity value, and an identifier associated with the plurality of location establishments that the aggregate severity value corresponds to.

25. The computer-implemented method of claim 13, wherein calculating a first aggregate severity value for a first aggregation unit comprises calculating a weighted average where a higher severity value is given more weight than a lower severity value.

26. A computer-readable, non-transitory storage medium having a computer program stored thereon for causing a suitably programmed computer system to process by one or more computer processors computer-program code for performing at least:
accessing by a computer system through a computer network quality-data from a plurality of quality-data sources, said quality-data representative of one or more of service quality, product quality, facility quality, safety quality, customer satisfaction, and employee satisfaction at the location establishments;
storing in an electronic data storage the quality-data as quality-data events, wherein a quality-data event is associated with a severity value and one or more of the location establishments;
calculating by the computer system a first aggregate severity value for a first aggregation unit, wherein the first aggregation unit is associated with a first plurality of quality-data events, at least in part based on the severity values of at least two of the first plurality of quality-data events;
calculating by the computer system a second aggregate severity value for a second aggregation unit, wherein the second aggregation unit is associated with a second plurality of quality-data events, at least in part based on the severity values of at least two of the second plurality of quality-data events; and
transmitting by the computer system the first aggregate severity value and the second aggregate severity value;

27. The computer-readable, non-transitory storage medium of claim 26, wherein the accessing is by querying a database of transaction data for at least 1000 transactions.
